(19) United States
(12) Patent Application Publication
(10) Pub. No.: US 2009/0111534 A1
(43) Pub. Date: Apr. 30, 2009

(54) HOUSING AND METHOD FOR MAKING THE SAME

(75) Inventors: BIN LU, Shenzhen (CN); GANG-YANG YU, Shenzhen (CN); HSIANG-JUNG SU, Shindian (TW); WEN-TE LAI, Shindian (TW)

Correspondence Address: PCE INDUSTRY, INC.;ATT. Steven Reiss, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/960,665

(22) Filed: Dec. 19, 2007

(30) Foreign Application Priority Data
Oct. 25, 2007 (CN) 200710202275.3

(51) Int. Cl. H04M 1/00

(52) U.S. Cl. 455/575.1

(57) ABSTRACT

A housing (10) with a pattern formed thereon includes a decorative outer wall (12). The decorative outer wall has a plurality of equidistant first grooves (121) and a plurality of second grooves (122) formed therein. Each of the second grooves intersects with at least one of the first grooves. Every two neighboring first grooves and every two neighboring second grooves define one of micro square-based pyramids, micro truncated triangular prisms, and micro frustums of square-based pyramid.

### BACKGROUND OF THE INVENTION

1. Field of the Invention

The present invention relates to housings, particularly to a housing with decorative pattern formed thereon.

2. Description of related art

Mobile devices, such as mobile telephones, personal digital assistants, or MP3 players, enable consumers to enjoy the convenience of high technology services, anytime and at virtually any location. These mobile devices often employ a variety of decorative housings to attract consumers. Paints and inks are typically applied onto surfaces of the housings to provide the necessary decorative appearance.

However, typical paints and inks are prone to be scratched out from the surfaces of the housings, thereby deteriorating the decorative appearance of the housings.

Therefore, a housing with decorative pattern is desired in order to overcome the above-described shortcomings.

### SUMMARY OF THE INVENTION

In one embodiment thereof, a housing with decorative pattern is provided. The housing includes a decorative outer wall. The decorative outer wall has a plurality of equidistant first grooves and a plurality of second grooves formed therein. Each of the second grooves intersects with at least one of the first grooves. Every two neighboring first grooves and every two neighboring second grooves define one of micro square-based pyramids, micro truncated triangular prisms, and micro frustums of square-based pyramid.

Other advantages and novel features will become more apparent from the following detailed description of preferred embodiments when taken in conjunction with the accompanying drawings.

### BRIEF DESCRIPTION OF THE DRAWINGS

Many aspects of the housing can be better understood with reference to the following drawing. The components in the drawing are not necessarily drawn to scale, the emphasis instead being placed upon clearly illustrating the principles of the housing. Moreover, in the drawing like reference numerals designate corresponding parts throughout the several views therein:

FIG. 1 is a perspective view of a first embodiment of a housing with decorative pattern;

FIG. 2 is an enlarged view of a circled portion 11 of FIG. 1;

FIG. 3 is a sectional view at a first angle enlarging a first portion of the housing shown in FIG. 1;

FIG. 4 is a sectional view at a second angle enlarging a second portion of the housing shown in FIG. 1;

FIG. 5 is a sectional view of a second embodiment of a housing;

FIG. 6 is a perspective view of the housing shown in FIG. 5;

FIG. 7 is a sectional view of a third embodiment of a housing;

FIG. 8 is a perspective view of the housing shown in FIG. 7;

FIG. 9 is a plan view of a cutting device; and

FIG. 10 is a flow chart of a method for making the housing shown in FIG. 1.

### DETAILED DESCRIPTION OF THE INVENTION

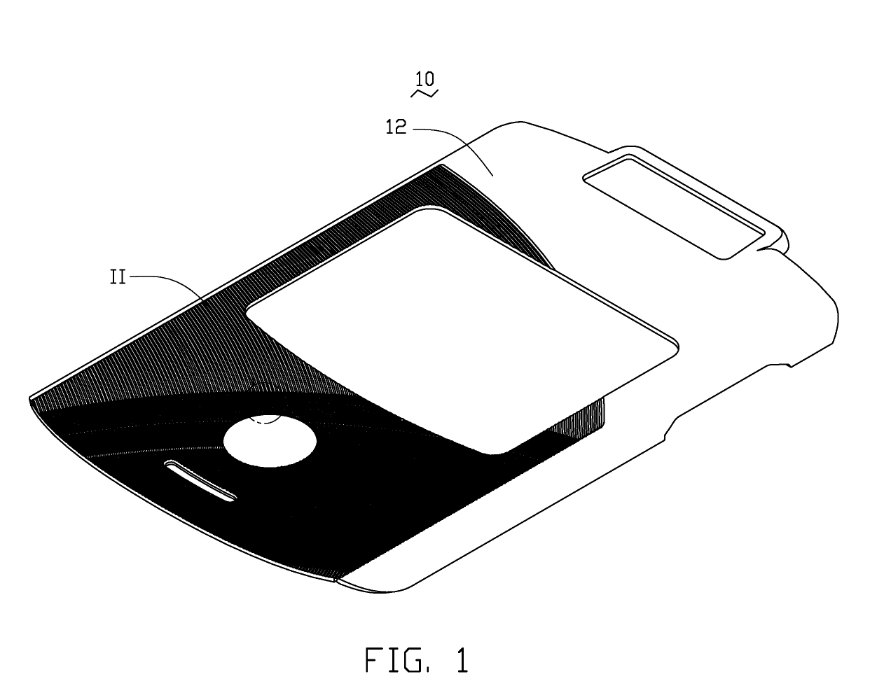

Referring to FIG. 1, in a first embodiment, a metal housing 10 includes a decorative outer wall 12.

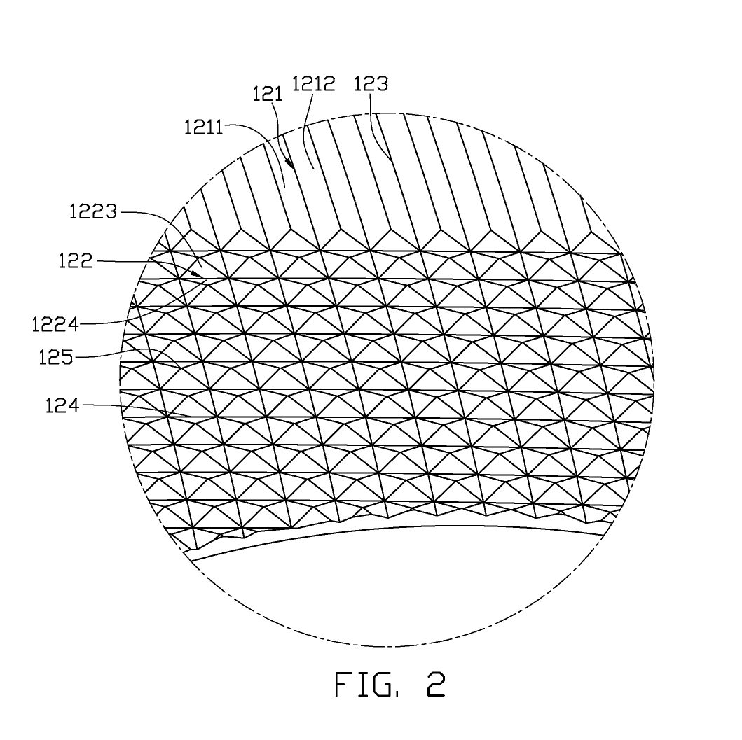

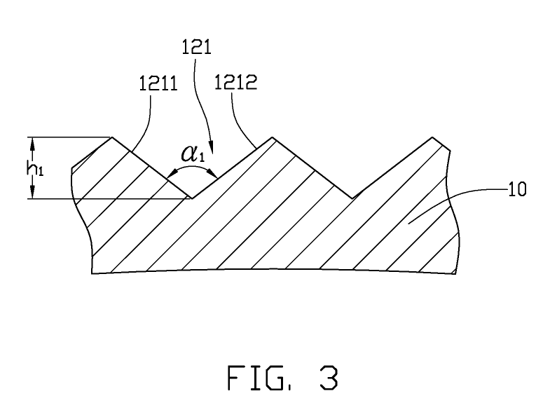

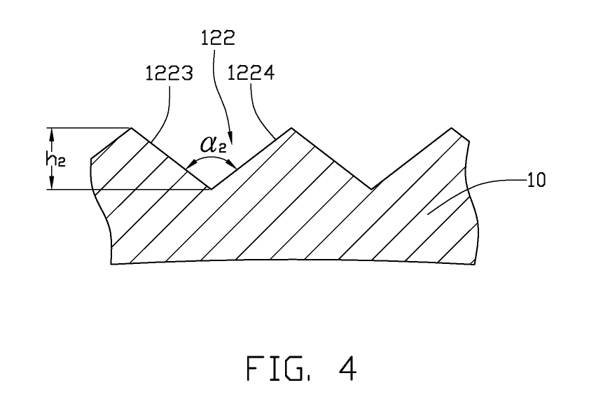

Referring to FIG. 2, FIG. 3, and FIG. 4, the decorative outer wall 12 has a plurality of equidistant first grooves 121 and a plurality of equidistant second grooves 122 formed therein. Each of the first grooves 121 and the second grooves 122 has a V-shaped cross section. Each of the first grooves 121 is defined by a first groove wall 1211 and a second groove wall 1212. The first groove wall 1211 and the second groove wall 1212 define an angle α₁ in an approximate range from 100° to 160°. The depth hi of each of the first grooves 121 is in an approximate range from 0.26 mm to 0.3 mm. Each of the second grooves 122 is defined by a third groove wall 1223 and a fourth groove wall 1224. The third groove wall 1223 and the fourth groove wall 1224 define an angle α₂ in an approximate range from 100° to 160°. The depth h₂ of each of the second grooves 122 is in an approximate range from 0.26 mm to 0.3 mm.

Each of the first grooves 121 extends along a corresponding first curvilinear path 123. The first grooves 121 are parallel to each other. The first groove wall 1211 of one of every two neighboring first grooves 121 adjoins the second groove wall 1212 of the other one of the two neighboring first grooves 121. That is, every two neighboring first grooves 121 abut against each other.

Each of the second grooves 122 extends along a corresponding second curvilinear path 124. The curvature of the second curvilinear path 124 is the same as that of the first curvilinear path 123. The second grooves 122 are parallel to each other. The third groove wall 1223 of one of every two neighboring second grooves 122 adjoins the fourth groove wall 1224 of the other one of the two neighboring second grooves 122. That is, every two neighboring second grooves 122 abut against each other.

Each of the second grooves 122 intersects with at least one of the first grooves 121. Thus, a plurality of micro square-based pyramids 125 are formed, due to the intersection of the first grooves 121 with the second grooves 122. Every two neighboring first grooves 121 and every two neighboring second grooves define one of the micro square-based pyramids 125. That is, the first groove wall 1211 of one of the two neighboring first grooves 121, the second groove wall 1212 of the other one of the two neighboring first grooves 121, the third groove wall 1223 of one of two neighboring second grooves 122, and the fourth groove wall 1224 of the other one of the two neighboring second grooves 122 define one of micro square-based pyramids 125. The micro square-based pyramids 125 form a first decorative pattern attractive to consumers. The micro square-based pyramids may improve appearance of the metal housing 10 and are not prone to be scratched out from the metal housing 10.

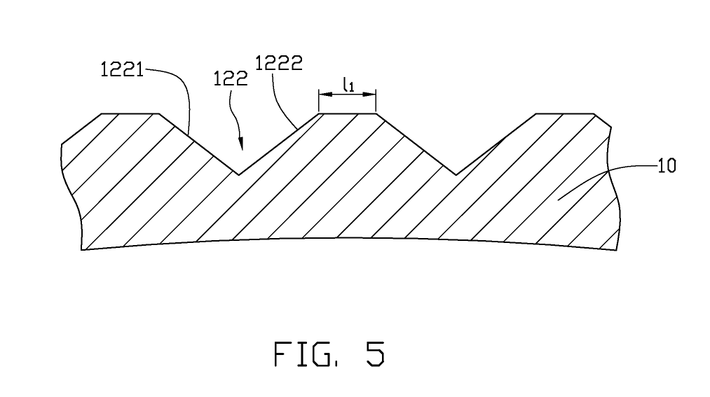

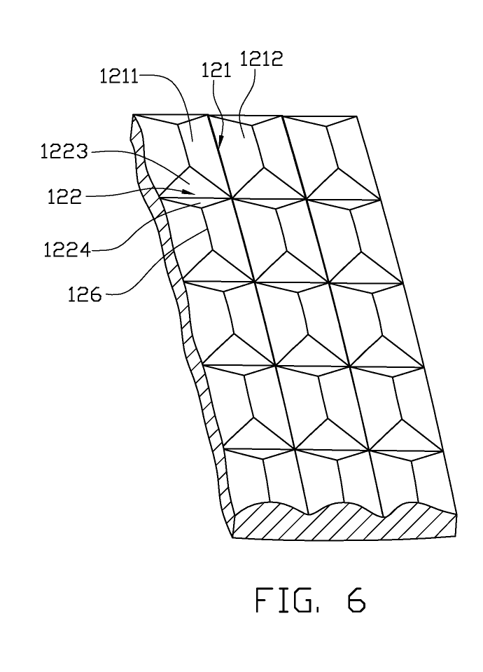

Referring to FIG. 5 and FIG. 6, in a second embodiment, the second grooves 122 are spaced each other. The distance 11 between every two neighboring second grooves 122 is less than 0.3 mm. Every two neighboring first grooves 121 abut against each other. Each of the second grooves 122 intersects with at least one of the first grooves 121. Thus, a plurality of micro truncated triangular prisms 126 are formed, due to the intersection of the first grooves 121 with the second grooves 122. The micro truncated triangular prisms 126 form a second decorative pattern attractive to consumers.

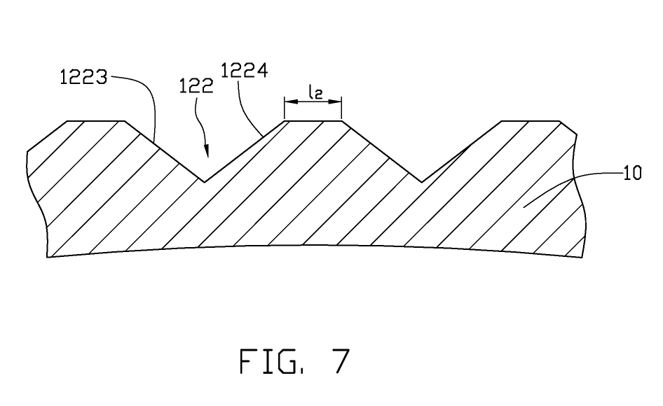

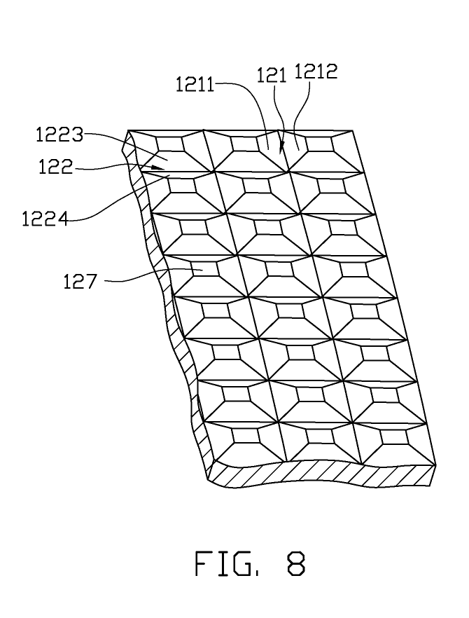

Referring to FIG. 7 and FIG. 8, in a third embodiment, every two neighboring first grooves 121 have a distance defined therebetween. The distance between every two neighboring first grooves 121 is less than 0.3 mm. The distance 12 between every two neighboring second grooves 122 is also less than 0.3 mm. Each of the second grooves 122 intersects with at least one of the first grooves 121. Thus, a plurality of micro frustums of square-based pyramid 127 are formed, due to the intersection of the first grooves 121 with the second grooves 122. The micro frustums of square-based pyramid 127 form a third decorative pattern attractive to consumers.

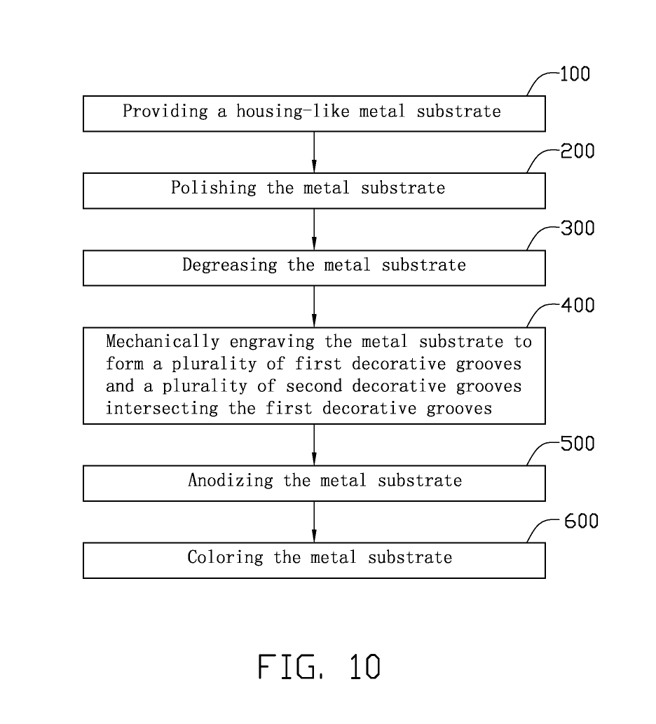

Referring to FIG. 10, a method for making the housing 10 includes steps 100 to 800. In step 100, a metal sheet (not shown) is punched into a housing-like metal substrate 11.

In step 200, the metal substrate 11 is chemically polished, in order to smooth and clear the surface of the metal substrate 11. During the chemical polishing step, the metal substrate 11 is immersed into a chemical polishing solution containing about 0.9 g/ml to 1.3 g/ml phosphoric acid and about 0.25 g/ml to 0.4 g/ml sulfuric acid for 20 to 30 seconds at a temperature of 90 to 110° C. It is to be further understood that a chemical-mechanical polishing (CMP) step, as well, is considered to be within the scope of the present chemical polishing step.

In step 300, a process for degreasing a surface of the metal substrate 11 is carried out using, advantageously, an alkali-based cleaning solution so as to remove oil stains on the metal article. After being degreased, the metal article is subsequently rinsed in flowing water. It is to be understood that, additionally or alternatively, other degreasing agents, such as surfactants, could be employed in step 300.

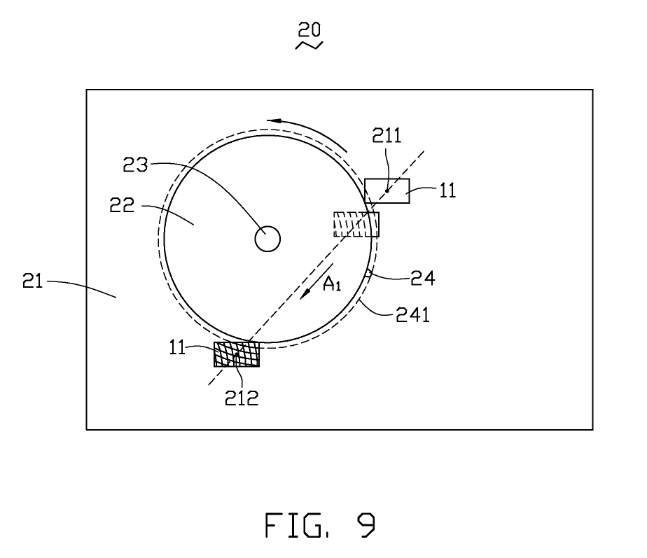

In step 400, referring to FIG. 9, the metal substrate 11 is mechanically engraved via a cutting device 20. The cutting device 20 includes a platform 21, a turntable 22, a shaft 23, and a cutting tool 24. The shaft 23 is vertically mounted on the platform 21. The turntable 22 is rotatably mounted around the shaft 23. An angle of cutting edge of the cutting tool 24 is in an approximate range from 100° to 160°. The cutting tool 24 is fixed to a flange of the turntable 22. The metal substrate 11 is disposed on the platform 21. The metal substrate 11 is moved along a direction A, from a first position 211 on the platform 21 to a second position 212 on the platform 21 at a speed of 600 to 800 mm per minute, as the turntable 22 is rotated at a speed of 1800 to 2200 revolutions per minute. The line connecting the first position 211 to the second position 212 divide a circular rotation path 241 of the cutting tool 24 into two segments of the circular rotation path 241. During the movement of the metal substrate 11, the cutting tool 24 engraves the metal substrate 11 to form the first grooves 121 and the second grooves 122 into the metal substrate 11.

In step 500, an anodizing process is then performed upon the metal substrate 11. As such, an anodic oxide layer with a plurality of fine pores therein is formed on the metal substrate 11.

In step 600, the metal substrate 11 is immersed into a dye solution, so as to color the metal substrate 11. The dye solution contains an organic dye in a concentration in an approximate range from 1 g/l to 10 g/l. During the coloring of the metal substrate 11, dye particles in the dye solution penetrate into the pores of the anodic oxide layer of the metal substrate 11, thus coloring the metal substrate 11. As such, the housing 10 is obtained.

It should be also understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A housing with decorative pattern formed thereon, comprising:
a decorative outer wall having a plurality of equidistant first grooves and a plurality of second grooves;
wherein each of the second grooves intersects with at least one of the first grooves, every two neighboring first grooves and every two neighboring second grooves defining one of micro square-based pyramids, micro truncated triangular prisms, and micro frustums of square-based pyramid.

2. The housing as claimed in claim 1, wherein each of the first grooves and the second grooves has a V-shaped cross section.

3. The housing as claimed in claim 1, wherein each of the first grooves is defined by a first groove wall and a second groove wall, the first groove wall and the second groove wall defining an angle in an approximate range from 100° to 160°.

4. The housing as claimed in claim 3, wherein the first groove wall of one of every two neighboring first grooves adjoins the second groove wall of the other one of the two neighboring first grooves.

5. The housing as claimed in claim 3, wherein the first grooves are parallel and spaced to each other, and a distance between every two neighboring first grooves is less than 0.3 mm.

6. The housing as claimed in claim 1, wherein each of the second grooves is defined by a third groove wall and a fourth groove wall, the third groove wall and the fourth groove wall defining an angle in an approximate range from 100° to 160°.

7. The housing as claimed in claim 6, wherein the third groove wall of one of every two neighboring second grooves adjoins the fourth groove wall of the other one of the two neighboring second grooves.

8. The housing as claimed in claim 6, wherein the second grooves are parallel, and every two neighboring second grooves define a distance therebetween less than 0.3 mm.

9. The housing as claimed in claim 1, wherein the depth of each of the first grooves and the second grooves is in an approximate range from 0.26 mm to 0.3 mm.

10. The housing as claimed in claim 1, wherein each of the first grooves extends along a corresponding first curvilinear path, each of the second grooves extending along a corresponding second curvilinear path, the curvature of the second curvilinear path being the same as that of the first curvilinear path.

11. A method for making a housing with decorative pattern, comprising the steps of:
providing a metal substrate;
providing a cutting device, the cutting device including a platform, a turntable, a shaft, and a cutting tool, the shaft being vertically mounted on the platform, the turntable being rotatably mounted around the shaft, the cutting tool being fixed to a flange of the turntable;
disposing the metal substrate on the platform;
moving the metal substrate from a first position under a flange of the turntable to a second position under a flange of the turntable, as the turntable with the cutting being rotated around the shaft;
wherein during the movement of the metal substrate, the metal substrate is engraved by the cutting tool to form a plurality of first grooves and a plurality of second grooves intersecting with the first grooves therein.

12. The method as claimed in claim 11, wherein the metal substrate is moved at a speed of 600 to 800 mm per minute, as the turntable being rotated at a speed of 1800 to 2200 revolutions per minute.

13. The method as claimed in claim 11, wherein an angle of cutting edge of the cutting tool is in an approximate range from 100° to 160°.
